(19) United States
(12) Patent Application Publication
(10) Pub. No.: US 2018/0025604 A1
(43) Pub. Date: Jan. 25, 2018

(54) VEHICLE OCCUPANT DETECTION AND ALERT SYSTEM

(71) Applicant: Protopsaltis Design Studios, Inc., Albertson, NY (US)

(72) Inventors: Anthony Protopsaltis, Albertson, NY (US); Dimitri Protopsaltis, Albertson, NY (US)

(21) Appl. No.: 15/656,934

(22) Filed: Jul. 21, 2017

Related U.S. Application Data
(60) Provisional application No. 62/365,209, filed on Jul. 21, 2016.

(51) Int. Cl. G08B 21/02; B60Q 9/00

(52) U.S. Cl. CPC G08B 21/0205; B60Q 9/00

(57) ABSTRACT

The present disclosure provides a vehicle occupant detection and alert system including an onboard apparatus including a controller operably connected to an occupancy sensor, an environment sensor and a transceiver. The controller generates a signal indicating that an occupant is present. A mobile communication device is operably connected to the transceiver. The mobile communication device includes a processor which upon execution of instructions performs the steps including:

receiving a signal from the controller indicating that an occupant is in the vehicle, responsive to an alert condition, initiating a first alert mode, wherein a first notification is generated and the functionality of the mobile device is restricted; and

generating a prompt to enter a code to acknowledge the first notification, wherein the functionality restriction is removed in response to entry of the code.

This application claims the benefit of priority to U.S. Provisional Patent Application Ser. No. 62/365,209 filed on Jul. 21, 2016, the content of which is incorporated by reference herein in its entirety.

### FIELD OF THE INVENTION

The present disclosure relates to a system for detecting an occupant in a vehicle, and more particularly, a system for detecting and providing an alert when an occupant is inadvertently left unattended in a closed vehicle.

### BACKGROUND

Since 1998, on average, 38 children die in hot cars each year from heat-related deaths after being trapped inside motor vehicles. Even the best of parents or caregivers can unknowingly leave a sleeping baby in a car; and the end result can be injury or even death. More than 70% of heat stroke deaths occur in children younger than age 2. Roughly 30% of heat stroke deaths occur because the child got in the car without a caregiver knowing and could not get out. Nearly 20% of deaths occur because a caregiver intentionally left the child in the car.

Shortwave energy from the sun heats objects that it strikes. For example, in summer months, a dark dashboard, steering wheel or seat temperatures often are in the range of 180 to over 200 degrees F. These objects (e.g., dashboard, steering wheel, child seat) heat the adjacent air by conduction and convection and also give off longwave radiation (red) which is very efficient at warming the air trapped inside a vehicle.

The temperature rise can happen fairly quickly. The temperature inside a vehicle can rise about 30 degrees in 20 minutes. A car can reach 110 degrees when temperatures are only in the 60 s. Heat stroke can take place when the outside temperature is as low as 57 degrees.

Extreme low temperatures can be equally dangerous to vehicle occupants left unattended and unable to exit the vehicle on their own. In addition, a young child left unattended in a vehicle, even in temperate climates where there is no danger posed by temperatures, can be at risk of injury or harm.

When there is a large group of occupants in a vehicle, such as a school bus, it is possible that a child can be inadvertently left in the vehicle after the vehicle is parked for the day. This can occur, for example, when a child falls asleep and is not readily visible to the driver. While bus operators may have procedures for personnel to manually check all seats in a bus to ensure that the bus is empty, children can still be inadvertently left in the vehicle.

Various devices have been developed to address the problem of unintended vehicle occupation, however, they fail to provide an alert that requires action and prevents the alert from being ignored or overridden.

### SUMMARY

The present disclosure provides a vehicle occupant detection and alert system including an onboard apparatus including a controller operably connected to an occupancy sensor, an environment sensor and a transceiver. The controller generates a signal indicating that an occupant is present. A mobile communication device is operably connected to the transceiver. The mobile communication device includes a processor which upon execution of instructions performs the steps comprising:

receiving a signal from the controller indicating that an occupant is in the vehicle, responsive to an alert condition, initiating a first alert mode, wherein a first notification is generated and the functionality of the mobile device is restricted; and

generating a prompt to enter a code to acknowledge the first notification, wherein the functionality restriction is removed in response to entry of the code.

The present disclosure also provides a vehicle occupant detection and alert system including an onboard apparatus including a controller operably connected to an occupancy sensor, an environment sensor and a transceiver. The controller generates a signal indicating that an occupant is present. A mobile communication device is operably connected to the transceiver. The mobile communication device includes a processor which upon execution of instructions performs the steps comprising:

receiving a signal from the controller indicating that an occupant is in the vehicle, responsive to a first alert condition indicating a temperature in the vehicle has exceeded a predetermined upper or lower limit, initiating a first alert mode, wherein a first notification is generated and the functionality of the mobile device is restricted; and

generating a prompt to enter a code to acknowledge the first notification, wherein the functionality restriction is removed in response to entry of the code.

The present disclosure further provides a multi-passenger vehicle occupant detection and alert system including an occupancy sensor to determine if an occupant is present in the vehicle. A controller is operably connected to the occupancy sensor. The controller generates a signal indicating that an occupant is present in the vehicle. A transceiver is operably connected to the controller. A mobile communication device is operably connected to the transceiver. The mobile communication device includes a processor which upon execution of instructions performs the steps comprising receiving a signal from the controller via the transceiver indicating that an occupant is in the vehicle. Responsive to an alert condition, a first alert mode is initiated, wherein a first notification is generated and the functionality of the mobile device is restricted. A prompt is generated to enter a code to acknowledge the first notification, wherein the functionality restriction is removed in response to entry of the code.

The present disclosure still further provides a multi-passenger vehicle occupant detection and alert system including a plurality of vehicle restrain systems, each including an occupancy sensor to determine if an occupant is present in the restraint system. A controller operably connected to the occupancy sensors, an environment sensor and a first transceiver. The controller generates a signal indicating that an occupant is present in one or both of the vehicle restraint systems. A mobile communication device is operably connected to the first transceiver.

The mobile communication device includes a processor which upon execution of instructions performs the steps including:

receiving a signal from the controller indicating that an occupant is in the vehicle, responsive to an alert condition, initiating a first alert mode, wherein a first notification is generated; and

generating a prompt to enter a code to acknowledge the first notification, wherein entry of the code cancels the alert mode, and failure to enter the code within a predetermined time initiates a second alert mode, wherein in the second alert mode a communication is generated to a communication device other than the mobile device.

### BRIEF DESCRIPTION OF THE DRAWINGS

FIG. 1 is a schematic of a vehicle detection and alert system.

FIG. 2A is a schematic of an onboard apparatus.

FIG. 2B is a schematic of an onboard apparatus shown in a vehicle.

FIG. 2C is a detailed view of a controller.

FIG. 3 is a side elevational view of a child restraint system.

FIG. 4 is a perspective view of a child safety restraint system including an electrical resistance switch.

FIG. 5 is a perspective view of a child safety restraint system including an occupancy sensor in the form of a pressure switch.

FIG. 6 is a perspective view of a child safety restraint system including an occupancy sensor in the form of a load cell.

FIG. 7 is a perspective view of a child safety restraint system including an occupancy sensor in the form of an infrared sensor.

FIG. 8 is a perspective view of a child safety restraint system including an occupancy sensor in the form of an optical sensor.

FIG. 9 is a perspective view of a child safety restraint system including an occupancy sensor in the form of a camera sensor.

FIGS. 10-13 are illustrations of a mobile device indicating a notification.

FIG. 14 is flow chart of the alert system.

FIG. 15 is a schematic showing a vehicle with a pair of child restraint systems.

FIG. 16 is a schematic showing a plurality of child restraint systems in a vehicle.

### DETAILED DESCRIPTION

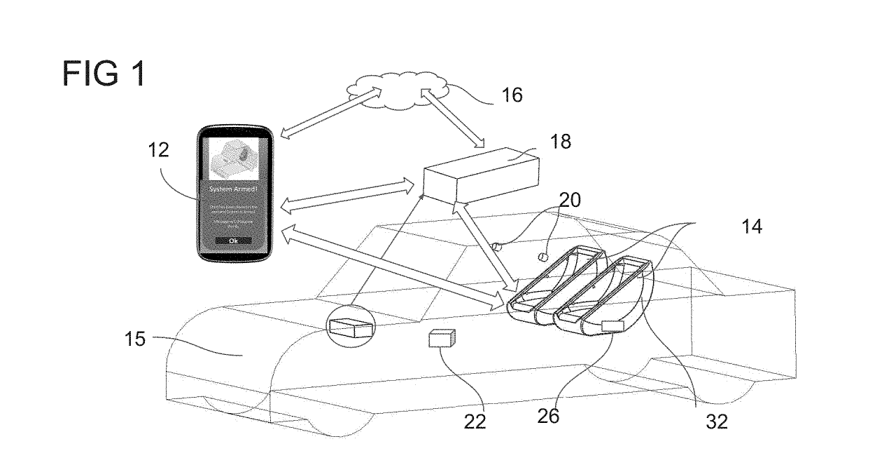

The present disclosure is directed to an alert system 10 for detecting the presence of an occupant in a vehicle and providing an alert when a vehicle occupant is left unattended within a vehicle. With reference to FIG. 1, the alert system 10 may be in wireless communication with a mobile communication device 12 running a software application capable of generating alert notifications to a user. The software running on the mobile device 12 will monitor inbound communication from onboard apparatus 14 in a vehicle 15 and provide notifications accordingly. The software application may be compatible with operating systems such as Android/IOS/Microsoft mobile/blackberry. The mobile device 12, such as a smart-phone, may generate an alert in response to information received from the onboard apparatus 14. The user must acknowledge the alert and correct the condition in a timely manner in order to terminate the alert condition. The mobile communication device 12 may communicate over a wireless network 16 to other entities including emergency services, e.g., the local police or fire department. The system 10 may include a gateway or hub 18 located in the vehicle 15 which can communicate with the onboard apparatus and/or the mobile communication device 12. The gateway 18 may include communication devices such as Bluetooth, Narrow Band IoT and/or cellular to permit communication with the mobile communication device 12 and/or a communication network 16.

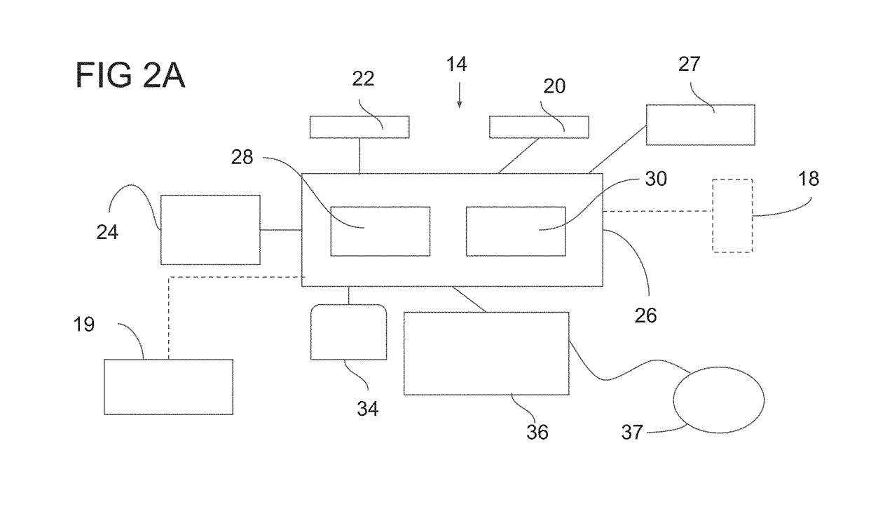

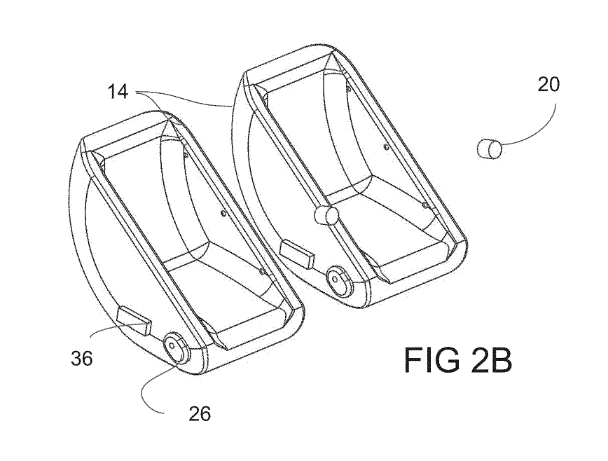

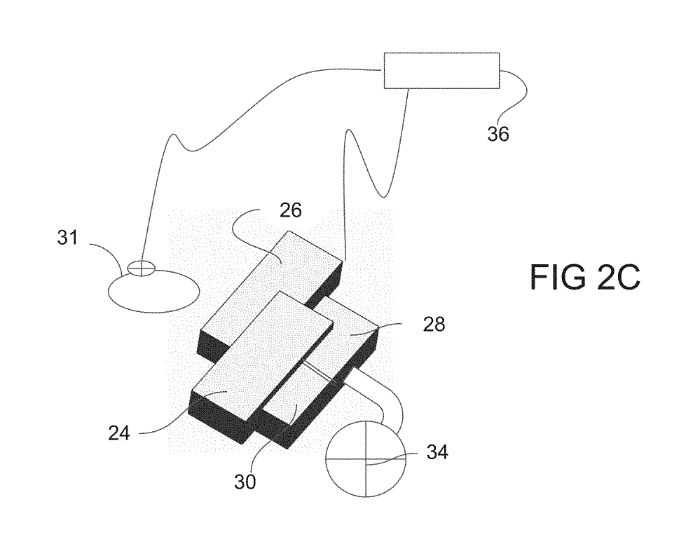

With reference to the FIGS. 2A, 2B and 2C, the onboard apparatus 14 may include one or more occupancy sensors 20 which sense the presence of an occupant within the vehicle 15. The onboard system further includes one or more environment sensors 22 which sense the conditions inside of the vehicle such as temperature. When certain predetermined conditions are met, a transceiver 24 will emit a signal that is to be received by the mobile device 12. Each of these elements may be operably connected to a controller 26, either hardwired or wirelessly. A transmitting device 27 is operably connected to the controller and may be capable of sending wireless, cellular and/or SMS communications. The controller 26, which may include a processor 28 and memory 30, receives the signals from the occupancy sensors 20 and the environment sensors. The memory 30 may store instruction executed by the processor. The user of the mobile communication device 12 must interact with the mobile communication device 12 in order to end the alert. If the unintended occupancy is not corrected, the alert will be generated, and one or more entities will be wirelessly contacted. The onboard apparatus 14 may also include an alert signal device 34 which is capable of issuing visual or audible alert. The controller may be connected to the gateway or hub 18. The controller 26 may be operably connected to the vehicle's control system 19, such as the CanBus system, so that features and functions of the vehicle can be accessed and utilized. For example, in response to an alert, the vehicle windows could be opened or the horn and lights could be activated.

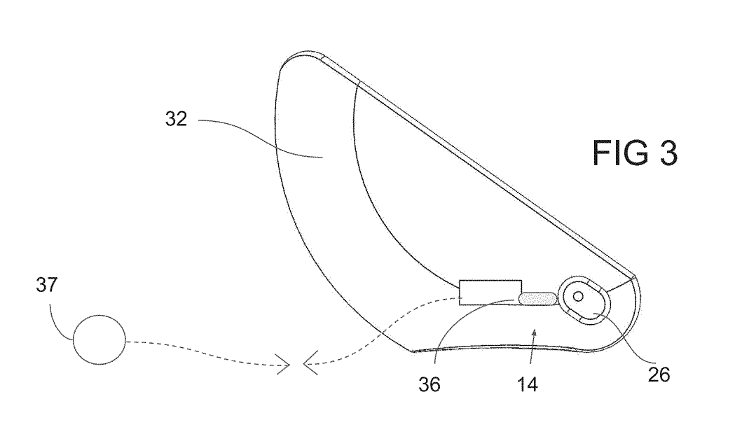

With reference to FIG. 3, the onboard apparatus 14 may be part of a child safety restraint system such as a child car seat 32. One or more of the components that make up the onboard apparatus may be integrated into the seat. In addition to, or as an alternative, one or more of the components of the onboard system 14 may be in the form of a device that is wearable by the occupant.

When a child is placed in the seat 32, the onboard apparatus 14 will detect the child's presence. The controller 26 will send an armed trigger signal to the mobile software application running on the mobile device 12. As long as the occupant remains in the seat/vehicle the system 10 will maintain an armed status. IR sensor, accelerometer, optical sensor, and or pressure switch can all be used to generate the armed status. In order to disarm, the child must be removed from seat/vehicle.

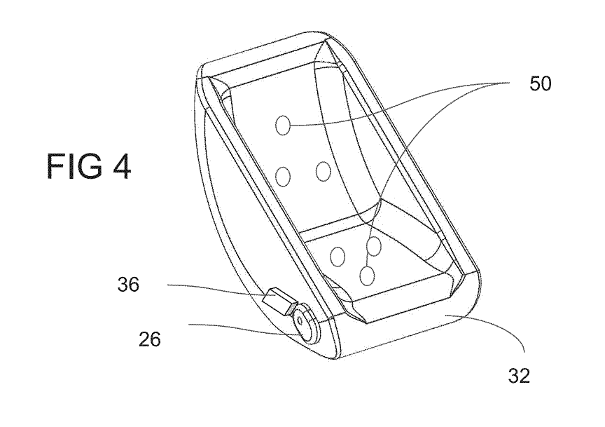

The system 10 is able to detect the presence of an occupant within the seat 32 using the occupancy sensor(s) 20. The occupancy sensor 20 may be integrated into a child safety restraint system. With reference to FIG. 4, in one embodiment, the occupancy sensor may be in the form of a low current resistance switch 40 formed into a foam cushion pad 42 of the car seat 32. The foam cushion pad 42 may have a low voltage current running through the entire area of the foam seat. The current will have a constant resistance that will indicate “at rest” or “empty seat”. When a load is applied, the foam increases its resistance to the low voltage current and any rise in Ohms from its “at rest” state will trigger the controller to signal the mobile device to an “Alarm Mode”. When the child is removed form the seat, the system will trigger the controller 26 to signal the mobile device to Alarm Mode Off” and reset the alert system 10.

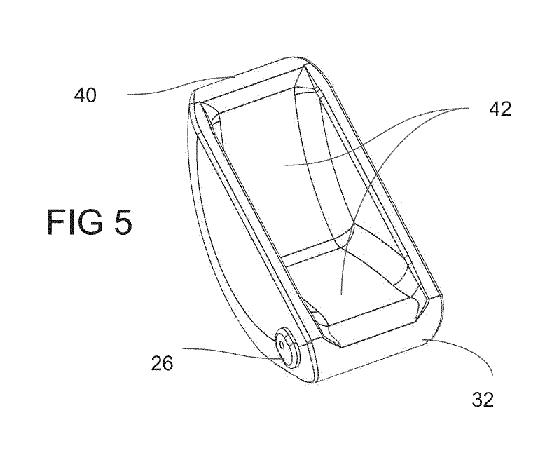

In an alternative embodiment, the occupancy sensor 20 may be in the form of a pressure switch 50. With reference to FIG. 5, one or more spring type button switch(s) 50 will be placed strategically on the seat 32. When any of the switch(s) are depressed the module will signal the mobile device to “Alarm Mode”. When the child is removed from the seat, the system will trigger the controller 26 to signal the mobile device 12 to “Alarm Mode Off” and reset the alert system 10.

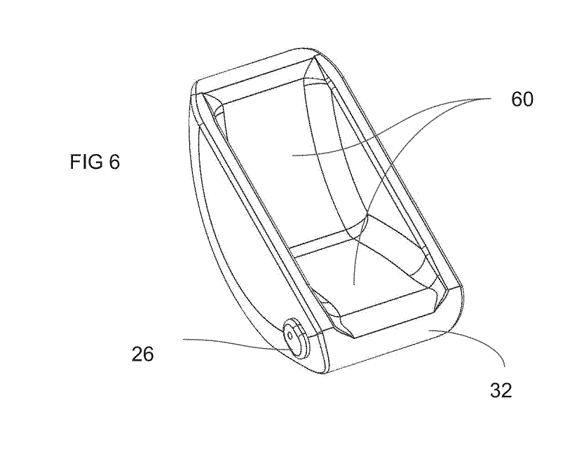

In a further alternative embodiment, the occupancy sensor 20 may be in the form of a load cell 60 as shown in FIG. 6. A load cell 60 may be a transducer that is used to create an electrical signal whose magnitude is directly proportional to the force being measured. One or more load cells 60 may be placed on the child seat 32. When a load is applied, an electrical signal proportional to the load is generated. When the output of the load cell 60 indicates the presence of a load, the controller 26 will signal the alert system 10 to arm. Once the load is removed, the controller will signal to disarm the alert system 10.

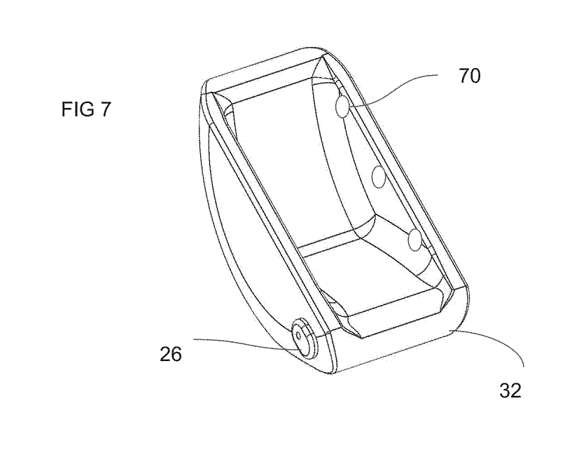

In still a further alternative embodiment shown in FIG. 7, the occupancy sensor 20 may be in the form of an infrared sensor 70. One or more IR sensors 70 may be placed on the child seat 32 in a position where any placement of a child will disrupt the beam. Any disruption of the beam or any disruption of a combination of beams will send a signal to the controller 26 which in turn signals the mobile device 12 and triggers the alarm mode. When the child is removed from the seat 32, the infra red sensors 70 will detect, this and the controller will trigger the module to signal the mobile device to Alarm Mode Off” and reset the system.

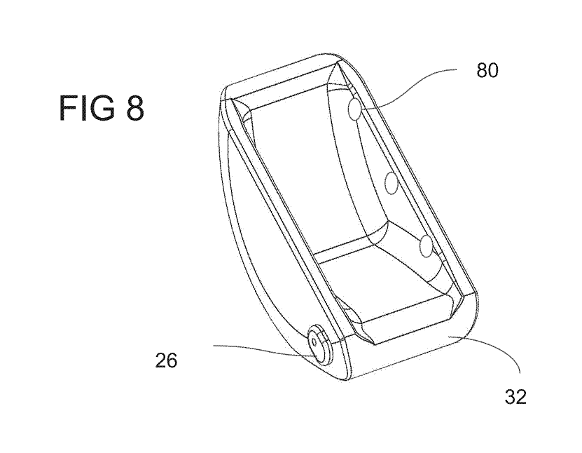

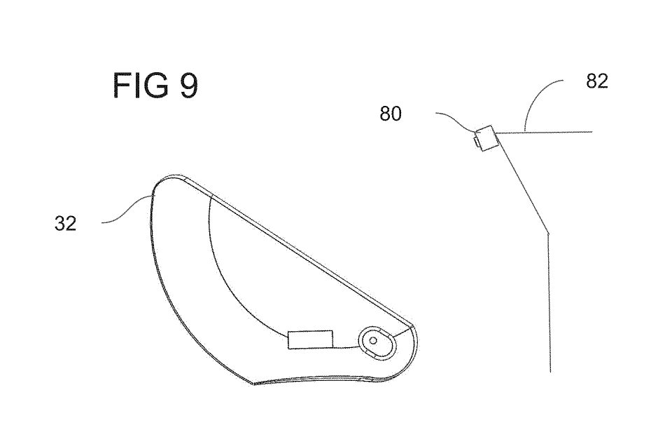

With reference to FIGS. 8 and 9, the occupancy sensor 20 could also be in the form of optical sensors 80 or a vision system. These sensors 80 may be located on the seat 32 (FIG. 8) or placed on the back of the vehicle front seats 82 (FIG. 9), facing the child seat 32. One or more vision system camera(s) can be utilized to map the seat without the occupant. Setting any object onto the child seat 32 will alter the mapped image and send the signal to the mobile device via the controller, registering a change. Once the image has been mapped any change will trigger the system to alarm mode. When the child is removed from the child seat 32, the alert system will trigger the controller 26 to signal the mobile device 12 to alarm mode off” and reset the alert system 10.

The controller 26 may also be operably connected to the environment sensors 22. Signals from the environment sensors are used by the controller 26 to determine if the environmental conditions in the vehicle exceed a predetermined threshold. As set forth in detail below, when the alert system 10 is armed and the threshold conditions are exceeded, the controller 26 causes an alert signal to be generated. Such a signal may be transmitted by the transceiver 24. The transceiver may use a short range communication protocol such as WiFi or Bluetooth. Alternatively, the communication may be via Narrow Band IoT which a Low Power Wide Area Network (LPWAN) radio technology standard enables devices and services to be connected using cellular telecommunications bands. The transceiver 24 may wirelessly connect to the mobile communication device 12 such that information may be transmitted between the controller and the mobile communication device. The connection protocol may be of a type known in the art such as where the mobile device is paired to the Bluetooth device. The software application may open when the mobile device 12 is turned on and run in the background. The mobile application and the system hardware work together in order to manage and notify the user of a potential danger of an occupant still in the vehicle.

In an alternative embodiment, the controller 26 may communicate with the gateway 18 located on the vehicle, either wirelessly or through a wired connection, and the gateway 18 may have a transceiver that communicates with the mobile communication device.

In one embodiment, the controller 26 may be used to determine if an alert condition exists and then causes an alert signal to be transmitted to the mobile device. Alternatively, the onboard apparatus 14 may simply transmit information as to occupancy and temperature or other data and the mobile device running the software application will determine if an alert condition exists.

The system may also include an accelerometer which is used to determine if the vehicle is still in motion or that the child is still in the vehicle.

In one embodiment, the system may be operably coupled to the vehicle's controller Area Network (CAN bus). This permits the alert system 10 to interact with the vehicles onboard systems and use those systems for monitoring, obtaining information, and providing alerts.

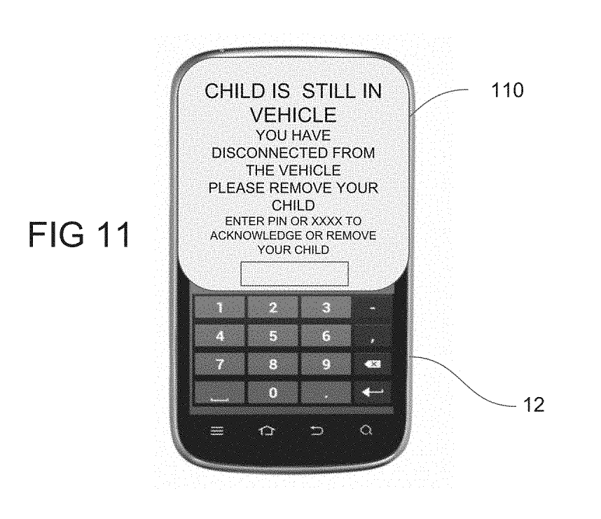

Several modes and alarms may be implemented to manage and help control the awareness of the user and the environment. One mode of an alarm is based on the proximity of the mobile device to the vehicle having the onboard apparatus and occupant. This mode is intended to prevent the user from unintentionally leaving the child in the vehicle and walking away, and is not limited to particular environmental conditions. The onboard apparatus 14 will communicate with the mobile device 12 to determine the distance between the mobile device and the vehicle. Should the mobile device exceed a certain predetermined distance, a signal will be generated providing an alert by the mobile device, FIG. 11, indicating that the child is still in the seat. Therefore, if the driver should inadvertently leave a child in the vehicle and start walking away, they can be alerted even before any dangerous situation arises.

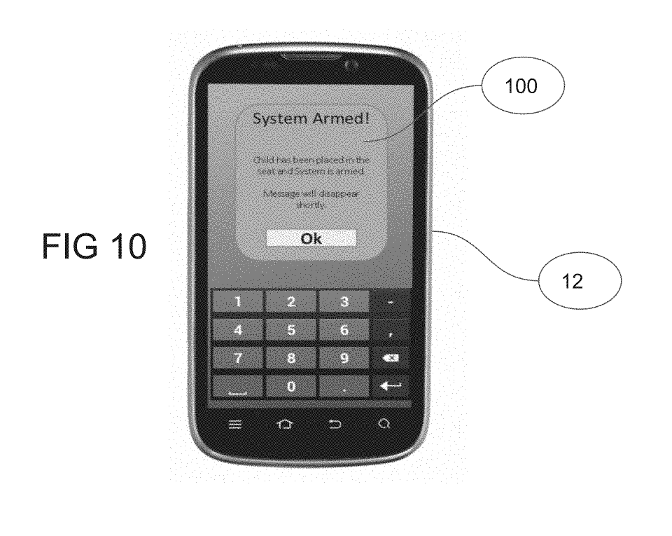

When the child is placed with in the seat, the system will be armed and the mobile device will display a system armed notification 100 as shown in FIG. 10. If an alert condition is present, the system 10 will transmit a signal to the mobile communication device 12. The application software will cause the mobile device 12 to generate a visual alert notification 110 on the screen (FIG. 11) and/or generate an audible alert and/or vibration using the mobile device's standard alert elements. The alert notification for exceeding the distance can also be set to lock the mobile device and require a code such as a personal identification number, PIN, to be entered before the device can be used. The features of the mobile device will be restricted with the only action permitted being calling emergency services, e.g. 911. With reference to FIG. 11, the visual alert may be a full screen notification that will include an entry box 112 in which a PIN must be entered. An audible alert may trigger repeatedly at predetermined intervals, e.g. every 30 seconds, until the PIN is entered. Once the PIN is entered the notification state will be suspended. This will suspend further notifications for the next software programmable amount of minutes, not to exceed a predetermined maximum. By locking the mobile device, the user is unable to ignore the signal and use the various functionalities of the mobile device 12.

The location can be determined using the GPS location system of the mobile device of a type known in the art. Alternatively, the vehicle and or, the onboard system 14 may have Global Navigation Satellite System (GNSS) that is used to pinpoint the geographic location of a receiver. If the communication between the mobile device 12 and onboard system 14 is via a wireless protocol such as Bluetooth or other short distance communication protocol, should the wireless connection between the mobile device 12 and the onboard apparatus 14 be lost due the range being exceeded, the mobile device notification alert can be initiated.

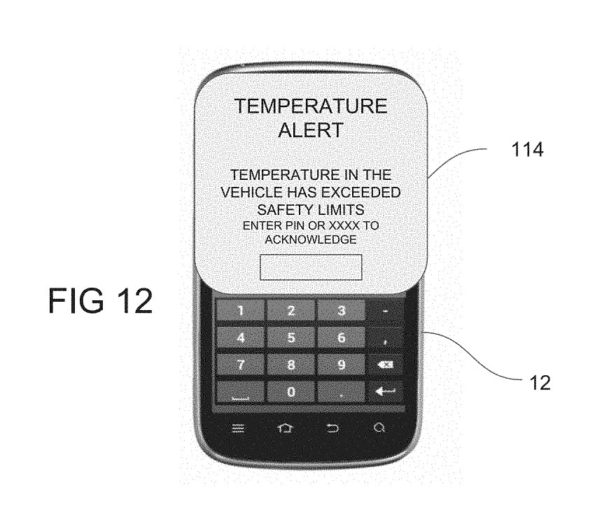

In addition to generating an alert notification based on proximity limits, the alert system 10 may generate alerts based on environmental parameters. One or more temperature sensors monitor the temperature in the vehicle to determine if a predetermined limit is exceeded. The temperature limit can be both on the high side and the low side. In the event that the limit is exceeded, the system 10 generates a signal received by the mobile communication device 12 running the software application. The software application running on the mobile device 12 initiates an alert notification 114 as shown in FIG. 12. This alert may be in the form of an audible, visual, and/or sensory (vibration) alert. The alert state will cause the software application to lock the mobile device and restrict its functionalities. The mobile device will remain locked and unusable until a predetermined PIN code is entered. The alert will trigger every 30 seconds until the PIN is entered.

The alert system may include an initial vehicle entry time delay feature. If a vehicle has been sitting in the sun, when the doors are first opened, the temperature may be beyond the alert limits. If a child is placed in the seat, thus arming the alert system, a warning signal could be immediately sent. To prevent such a false positive, a delay can be added to the alert system from the time a child is placed in the seat to when the alert system is armed. This time delay will permit the temperature in the vehicle to be stabilized before arming.

Once an alert is generated, a timer begins during which the alert must be acknowledged, the alert condition such as the extreme temperature is eliminated, or the occupant is removed from the seat. When the time period is exceeded an alert signal will be generated. This will cause the transceiver 24 to send a signal to the mobile device. The software running on the mobile device 12 will generate a notification message. Alternatively, the transceiver 24 may communicate with the gateway 18 and the gateway 18 through a transceiver may communicate with the mobile communication device 12.

If this notification message is not acknowledged by the user within a predetermined time, a secondary alert signal may then be generated. The secondary alert signal may cause the mobile communication device 12 or a transmitting device 25 in the vehicle to initiate a communication to a secondary contact. For example, the communication may be a text message or phone call to a predetermined phone number or numbers that the user has pre-designated using the application software. An automated message can be communicated advising the recipient of the alert condition communication and the location of the vehicle. For example, this may be a communication to a relative, neighbor, associate of the user or a monitoring service. The communication may be a phone call with an automated voice message, an email, and/or SMS. This secondary alert contact communication may be dependent on the location of the vehicle. For example if the vehicle is in close proximity to the driver's work, a call to a predetermined work number could be generated. The location of the vehicle may be determined using a GPS device either on the vehicle or on the mobile device.

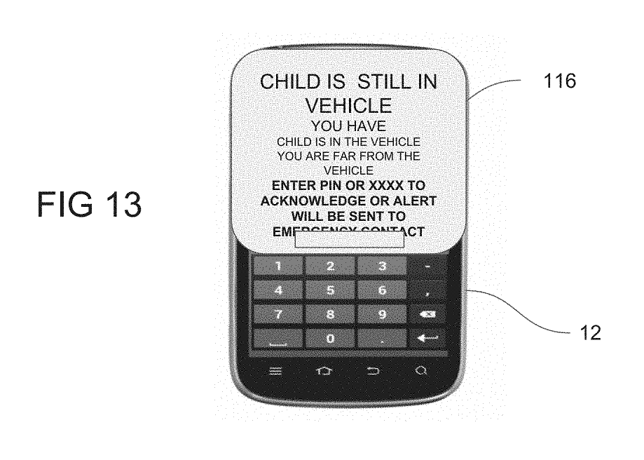

Once the secondary alert is generated, a predetermined time is set for the alert condition to be acknowledged and resolved. If the alert condition is not resolved in the predetermined time, e.g. 5 minutes, a tertiary emergency alert may be generated. The software application running on the mobile device 12 initiates an emergency alert notification 116 as shown in FIG. 13. The tertiary alert may trigger an emergency mode during which emergency services are contacted. The mobile communication device 12, or the in-vehicle cellular device 25, will dial an emergency number and play an automated message, providing GPS coordinates if available and requesting support to the location of the vehicle. One or more additional emergency numbers may be listed. For example, a call to 911 may be initiated. This alert must be acknowledged by entering a PIN. Only then will the full functionality of the mobile device be restored.

Depending on the alert condition, the system may bypass the secondary alert, and generate the tertiary emergency alert right after the first alert is not timely acknowledged. For, example, if the temperature in the vehicle quickly builds to a very high temperature, the welfare of the occupant may require an immediate response. In such situation, the communication to emergency services may be made before or instead of the secondary alert.

After each alert is generated, the mobile device will receive a signal and a notification as to the state of the alert may be displayed. For example, if a user is out of contact with their mobile device, they can be updated as to the status of the alerts.

Temperature notification thresholds may be set by the user. For example, there may a warning level threshold at which the temperature is at a level that with extended duration could potentially be hazardous. The next level may be an Emergency level at which the temperature level is dangerous; extended exposure could mean loss of life. These temperature limits can be modified. However, the amount of modification may be limited to prevent certain limitations from being exceeded in the software.

As the system is generating the alert signal, communication may be sent to the mobile device providing information as to what signals have been sent and to whom. Such alert information may be displayed on the mobile device.

In the event that the user acknowledges the alert and enters the code, a time period may be set in which the alert condition is resolved. Only entering the PIN does not end the alert condition. For example, should the code be entered and the occupant remains in the vehicle having elevated temperatures, the secondary and or tertiary alert signals will be generated.

In the embodiment wherein the system is integrated into the vehicle's control system, such as the CanBus system, action taken can be undertaken by the systems and apparatus of the vehicle. For example, if the vehicle has an onboard communication system, this communication system can be used to transmit the messages to the mobile device and/or transmit the alert signals.

In addition, the vehicle systems can be used to open the windows a certain degree, in order to try and moderate the temperatures. The vehicle horn or security siren could be activated in either or all of the alert signal stages to notify others of alert condition.

With reference to FIG. 2, the onboard apparatus may be powered by a rechargeable battery system 36 and/or a vehicle power supply 37 via an 12v cigarette lighter, for example. A battery indicator sensor may be provided. Should battery on the device fall to below a 15% capacity, a battery low notification will be sent to recharge or reconnect the device to external power. The notification signal may be transmitted to the mobile device 12. The user would then receive a notification on the mobile communication device 12 regarding the condition of the battery.

In addition to, or alternatively, an audible or visual indictor within the vehicle may be triggered to alert the user that the battery needs to be charged or replaced. Alternatively, the system may connected directly to the vehicles power system in order to receive or maintain power. However, even in this embodiment, the power level may be monitored. If it should fall below a predetermined level, a notification signal can be sent.

Should power disconnect on the mobile device while the alert system is armed, the alert system will stay armed until the state is resolved. The power would have to be re-established and connection to the mobile device would need to be established and verified. If the child has been removed from the seat or vehicle, the device will disarm when power and connection is established.

In order to remove alarm mode from a power failed device, a PIN code may be used to suspend/disable the product. Therefore as with the other alert condition noted above, a user would have to acknowledge the notification by entering a PIN code. The mobile communication device may be locked until the PIN is entered.

Should the wireless connection between the onboard apparatus and the mobile device be lost at any time when the system is armed, the software application will generate an alert. As with the other alerts, the user will be required to enter a PIN code in order to acknowledge the alert. If the alert is not acknowledged and or the condition is not corrected, secondary and tertiary alerts messages will be generated.

The application software running on the mobile device 12 will monitor inbound communication from the onboard apparatus and provide notifications accordingly. The application will prevent normal use of the mobile device to force a user to respond or otherwise take action.

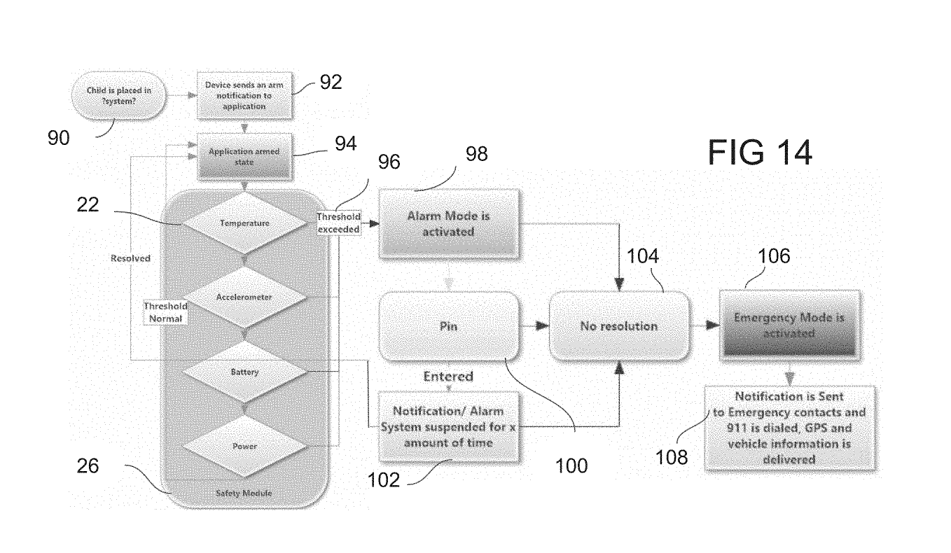

With reference to FIG. 14, an example of the operation of the detection and alert system will now be described. The onboard apparatus may be placed within the vehicle. When the onboard apparatus is in the form of a child car seat 14, it may be attached to the vehicle according to applicable safety rules. If the onboard apparatus 14 is to be connected to a power cord, the power may be connected. An occupant may be placed within the seat 32. When the onboard apparatus 14 is powered, the system transceiver 24 may be wirelessly paired to the mobile device 12. A notification will be generated by the software indicating that proper pairing has taken place.

When an occupant is placed within the seat 32, their presence is detected by the occupancy sensors 20 and a signal is generated 90. The sensors send signals to the controller 26 which determines that there is an occupant in the seat. The controller then generates a signal to arm the alert system 92. The signal causes the transceiver 24 to send a communication to the mobile device 12 and the software registers the alert system as armed 94. Various environmental parameters such as temperature, acceleration, battery, and power are monitored by the environment sensors 22 in communication with the controller 26.

In the armed mode, the software causes the mobile device to monitor communications from the transceiver and awaits a signal that triggers an alarm. One trigger would be the loss of the wireless connection between the mobile device and the transceiver of the onboard apparatus. Another alert trigger could be the distance between the mobile device and the vehicle exceeding a predetermined value.

When the alert system is armed, the environment sensors 22 monitor the temperature of the vehicle cabin. If the temperature exceeds the predetermined threshold 96, the controller will cause the transceiver to initiate a communication to the mobile device, activating the alarm mode and triggering an alert 98.

When the mobile device receives an alert signal, the application software will issue a notification. The software will lock the phone from all use except making a call to emergency services, e.g. calling 911. A notification screen will be displayed on the mobile device and will prompted the user to enter a PIN 100 in order to acknowledge the alert. Entering the PIN 102 will suspend the alert for a predetermined time. This time would give the user the opportunity to correct the situation, such as removing the occupant from the vehicle. If after that time, the condition causing the alert is not addressed, the alert notification will again be initiated, locking the mobile device.

In the event that the condition causing the alert is not addressed 104 with in a predetermined time, the alert system will initiate the secondary alert signal 106. This could be achieved by the mobile device making a call, or sending an SMS to a predetermined individual or individuals. The user may still enter the PIN and cancel the alert and correct the situation. The user may be alerted if a number was called or SMS sent so they can follow up and let the individual who received the call or message that the situation has been corrected.

If the alert condition is still not addressed within a second predetermined time, a third alert signal could be initiated. The third signal may make a communication to emergency services 108.

Accordingly, in a preferred embodiment, the alert system is not cancelled until the condition causing the alert is addressed, e.g., lowering of temperature, or the occupant is removed from the seat or the vehicle, thereby disarming the alert system.

While the description above describes a single onboard system in a vehicle it is within the contemplation of the present disclosure, that multiple onboard systems could be included in a single vehicle.

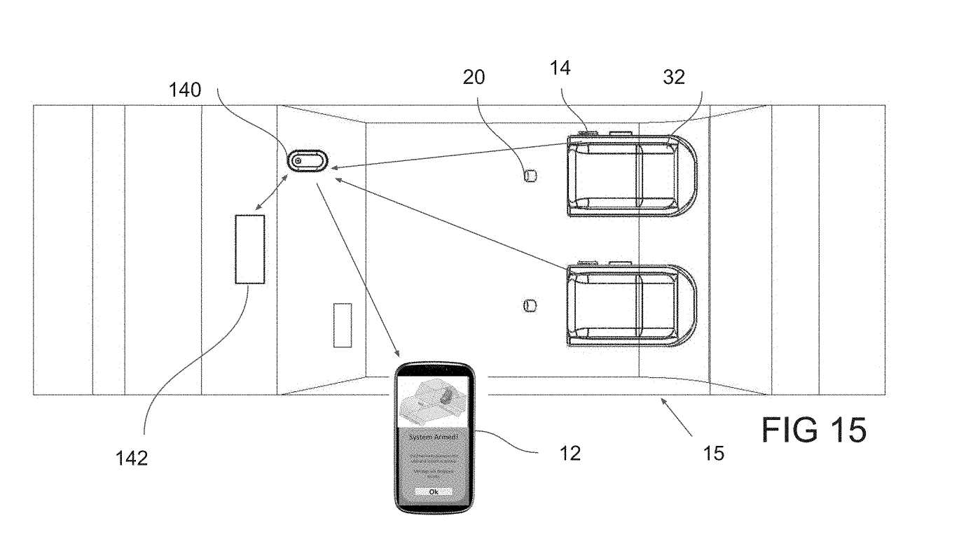

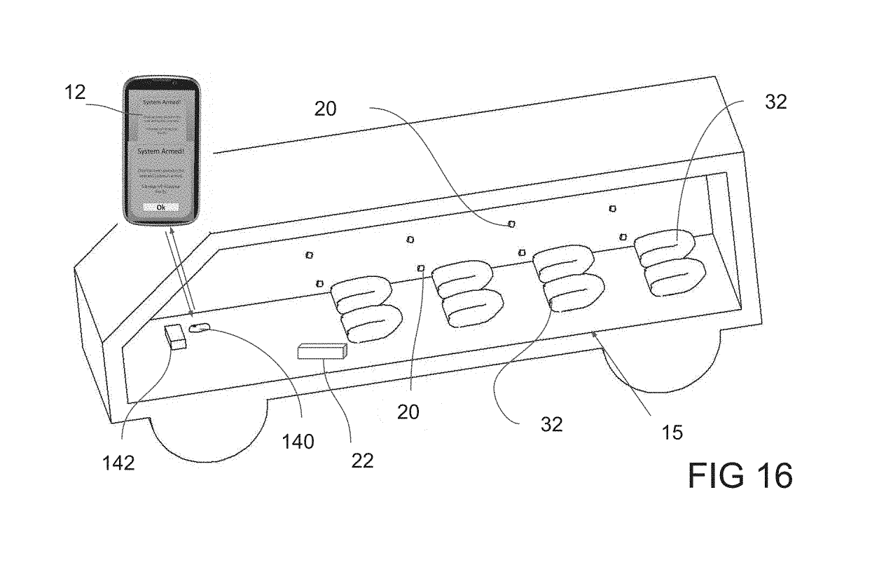

With reference to FIGS. 15 and 16, it is further contemplated that a vehicle 15 could have multiple safety restraint systems such as multiple child seats 32 with occupancy sensors 20. In this embodiment, each seat 32 may have an onboard system 14 operably connected to a wireless gateway device 140 such as a Bluetooth gateway device. The onboard system 14 connects to a gateway 140 in the vehicle which will be wired directly or connected via an accessory. The gateway may communicate with the mobile communication device 12 to transmit an alert signal. Multiple onboard systems 14 can communicate independently to the gateway 140. The gateway device may communicate to a vehicle bus 142. The gateway 140 acts as a hub for permitting multiple devices to communicate with the vehicle.

In the event the system is armed, i.e. the presence of an occupant is detected, and environment sensors 22 of the onboard system 14 detect an overheat situation, the connection to the vehicle's bus would permits the vehicle's systems to be operated to help alleviate the overheat situation. For example, the controller 26 can issue a signal causing the vehicle's windows to be lowered and the vehicle's alarm to be activated. In addition, the vehicle's ventilation system and air conditioning may be activated to help lower the vehicle's interior temperature. These actions can be activated without the need of input or instructions from an operator.

In the event of an overheat situation, a notification can be issued, as described above, to notify a monitoring service of emergency an event via a mobile phone. The gateway device 140 may utilize updated Bluetooth Low Energy (BTLE) capabilities and connects to multiple devices simultaneously. This permits the devices to operate independently.

In addition, system 14 may detect the present of an occupant and issue an alert signal if the driver of the vehicle moves away from the vehicle a predetermined distance and the occupant remains in the vehicle. For example, if an embodiment wherein the vehicle is a commercial passenger bus as shown in FIG. 16, the sensors 20 detect the presence of an occupant. Should the bus driver exit the bus and move beyond a predetermined distance from the bus, the system may trigger an alert signal to be sent to the driver's mobile device 12. The mobile device 12 may be locked until a PIN is entered acknowledging the alert as described above. If the driver does not respond to the alert, the system may generate a secondary alert signal to cause an onboard communication device to call another predetermined party such as a bus company providing an alert. The alert may be an automated voice message, email and/or SMS. The call may include the location information of the bus. If after a predetermined time the signal is not acknowledged, a tertiary emergency alert may be generated to contact local authorities. The above alerts system can be generated regardless of the temperature inside the vehicle.

In a multi-passenger vehicle, such as a school bus, ensuring that all the passengers have disembarked is an important safety issue. In such environments, the alert condition may be that one or more occupants remain in the bus under certain conditions, such as when the bus has completed its route. The mobile communication device 12 may be docked to the vehicle and have a display and an input device. The communication device 12 may be operably connected to a controller and sensors as set forth above. If the onboard occupancy sensors detect the presence of one or more passengers onboard, an alert signal can be generated and send by the transceiver. The alert signal is then sent to the mobile communication device which may display and alert notification such as, Passenger(s) Still Onboard. The bus operator would then need to correct the condition and enter a PIN into the mobile communication device in order to cancel the alert. Failure to do so with in a predetermined time may cause a secondary alert wherein a communication is made by the transceiver to a communication device other than the mobile communication device 12, such as the bus company. If that is not acknowledged by the operator by entering a PIN within a certain time, then a tertiary alert including causing the transceiver to initiate a communication to emergency services. Alternatively, the alert system 10 could also, regardless of signals from occupancy sensors, require an operator to enter a PIN into a mobile communication device on the vehicle acknowledging that they have search the vehicle for passengers and none were found. It is further contemplated that GPS location information provided to the controller could be used to determine when to initiate an alert signal. For example, if a bus is located in the bus yard, or if a bus it at the last stop of its route, such locations could constitute a precondition for initiating an alert signal.

The communication between the devices can be via a mesh network. The devices can relay network communications via Bluetooth LE Mesh networking. The application operates a divides the communication for each device. There can be a Synchronous operation of devices. Each device communicates with each other and with a host device. No gateway is needed.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. An vehicle occupant detection and alert system comprising:
an onboard apparatus including a controller operably connected to an occupancy sensor, an environment sensor and a transceiver, the controller generating a signal indicating that an occupant is present;
a mobile communication device operably connected to the transceiver;
the mobile communication device including a processor which upon execution of instructions performs the steps comprising:
receiving a signal from the controller indicating that an occupant is in the vehicle, responsive to an alert condition, initiating a first alert mode, wherein a first notification is generated and the functionality of the mobile device is restricted; and
generating a prompt to enter a code to acknowledge the first notification, wherein the functionality restriction is removed in response to entry of the code.

2. The system as defined in claim 1, wherein the alert condition indicates that a parameter exceeds a predetermined limit.

3. The system as defined in claim 2, wherein the parameter includes one of an insider vehicle temperature and a distance between the vehicle and the mobile device.

4. The system as defined in claim 1, wherein the processor initiates a second alert mode if the alert condition is not resolved in a predetermined time.

5. The system as defined in claim 4, wherein in the second alert mode a communication is generated to a communication device other than the mobile device, the communication including information as to the alert and the location of the vehicle.

6. The system as defined in claim 4, wherein the processor initiates a third alert mode if the alert condition is not resolved in a predetermined time.

7. The system as defined in claim 4, wherein a communication is generated to an emergency services agency, the communication including information as to the alert and the location of the vehicle.

8. The system as defined in claim 1, wherein the processor generates an alert notification in response to communication between the controller and the mobile device being interrupted.

9. The system as defined in claim 1, wherein the occupancy sensor is integrated in a child safety seat.

10. The system as defined in claim 1, wherein the mobile communication device is operably connected to the transceiver via Narrow Band IoT.

11. An vehicle occupant detection and alert system comprising:
an onboard apparatus including a controller operably connected to an occupancy sensor, and a transceiver, the controller generating a signal indicating that an occupant is present;
a mobile communication device operably connected to the transceiver;
the mobile communication device including a processor which upon execution of instructions performs the steps comprising:
receiving a signal from the controller indicating that an occupant is in the vehicle, responsive to a first alert condition indicating a temperature in the vehicle has exceeded a predetermined upper or lower limit, initiating a first alert mode, wherein a first notification is generated and the functionality of the mobile communication device is restricted; and
generating a prompt to enter a code to acknowledge the first notification, wherein the functionality restriction is removed in response to entry of the code.

12. The system as defined in claim 11, wherein a temperature sensor is operably connected to the controller.

13. The system as defined in claim 12, wherein the processor initiates a second alert mode if the alert condition is not resolved in a predetermined wherein a communication is generated to a communication device other than the mobile device, the communication including information as to the alert.

14. The system as defined in claim 11, wherein a second alert condition is generated when an occupant is detected within the vehicle and a distance between the vehicle and a mobile device of a vehicle driver exceeds a predetermined distance.

15. The system as defined in claim 11, wherein the onboard apparatus includes a child safety seat and the controller is operably connected to the child safety seat.

16. A multi-passenger vehicle occupant detection and alert system comprising:
a occupancy sensor to determine if a occupant is present in the vehicle;
a controller operably connected to the occupancy sensor, the controller generating a signal indicating that an occupant is present in the vehicle;
a transceiver operably connected to the controller;
a mobile communication device operably connected to the transceiver;
the mobile communication device including a processor which upon execution of instructions performs the steps comprising:
receiving a signal from the controller via the transceiver indicating that an occupant is in the vehicle,
responsive to an alert condition, initiating a first alert mode, wherein a first notification is generated and the functionality of the mobile device is restricted; and
generating a prompt to enter a code to acknowledge the first notification, wherein the functionality restriction is removed in response to entry of the code.

17. The system as defined in claim 16, wherein the alert condition indicates that a parameter exceeds a predetermined limit.

18. The system as defined in claim 17, wherein the alert condition is generated when an occupant is detected within the vehicle and a distance between the vehicle and a mobile device of a vehicle driver exceeds a predetermined distance.

19. The system as defined in claim 16, wherein the processor initiates a second alert mode if the alert condition is not resolved in a predetermined time.

20. The system as defined in claim 19, wherein the processor initiates a third alert mode if the alert condition is not resolved in a predetermined time.

21. The system as defined in claim 16, wherein a communication is generated to a communication device other than the mobile device, the communication including information as to the alert and the location of the vehicle.

22. The system as defined in claim 17, wherein the vehicle includes a plurality of vehicle restraint systems, each including an occupancy sensor to determine if an occupant is present in the restraint system, the controller being operably connected to each of the occupancy sensors.

23. The system as defined in claim 17, including an environment sensor is operably connected to the controller for sensing an environmental condition inside the vehicle, and the parameter includes an insider vehicle temperature.

24. The system as defined in claim 16, wherein the mobile communication device is operably connected to the first transceiver via Narrow Band IoT.

25. A multi-passenger vehicle occupant detection and alert system comprising:
a plurality of vehicle passenger restraint systems, each including an occupancy sensor to determine if an occupant is present in the restraint system;
a controller operably connected to the occupancy sensors, an environment sensor and a first transceiver, the controller generating a signal indicating that an occupant is present in one or both of the vehicle restraint systems;
a mobile communication device operably connected to the first transceiver;
the mobile communication device including a processor which upon execution of instructions performs the steps comprising:
receiving a signal from the controller indicating that an occupant is in the vehicle, responsive to an alert condition, initiating a first alert mode, wherein a first notification is generated by the first transceiver and displayed on the mobile device; and
generating a prompt to enter a code to acknowledge the first notification, wherein entry of the code cancels the alert mode, and failure to enter the code within a predetermined time initiates a second alert mode, wherein in the second alert mode a communication is generated to a communication device other than the mobile device.

26. The system as defined in claim 25, wherein each passenger restraint system is operable connected to a second transceiver, the second transceivers communicating information to the first transceiver.
